(19) United States
(12) Patent Application Publication
(10) Pub. No.: US 2009/0216838 A1
(43) Pub. Date: Aug. 27, 2009

(54) Event-based contact list methods

(75) Inventor: Michael M. Lee, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc.

(21) Appl. No.: 12/072,759

(22) Filed: Feb. 27, 2008

(51) Int. Cl. G06F 15/16

(52) U.S. Cl. 709/204

(57) ABSTRACT

Methods are provided for allowing an organizer of an event (such as a school reunion, a wedding, etc.) to create a site for the event on a server (e.g., an Internet server), and for allowing possible participants in the event to add information to the site and to retrieve information from the site. The methods preferably include fade-in and/or fade-out of certain information associated with the event. As an example of fade-in, a user may gradually be given access to more of another participant's contact information only after that other participant has responded to an initial contact from that user. As an example of fade-out, a user's device may gradually display an icon for the event less prominently if the event information is not being used.

### BACKGROUND OF THE INVENTION

This invention relates to methods for creating, using, and terminating lists of contact information, and more particularly to such contact lists that are associated with an event.

An event may be intended to bring together a number of people who otherwise are not in regular contact with one another. Examples of such events are certain kinds of business meetings, conventions, school or other organizational reunions, weddings, etc. In the time period leading up to the event it may be desirable to help participants or possible participants make preliminary contact with one another. After the event it may be desirable to continue to help participants make contact with one another. However, it may also be desirable to subject the contact help thus offered before and/or after the event to some controls (e.g., so that a participant does not receive contacts of kinds or at times that the participant does not want).

### SUMMARY OF THE INVENTION

In accordance with certain possible aspects of the invention, a method of facilitating an event that will have a plurality of participants may include allowing each participant to post on a network site (e.g., an Internet site) for the event first and second contact information for that participant. Use of the first contact information (e.g., email address information) may be less restricted than use of the second contact information (e.g., telephone contact information). For example, a participant's second contact information may be restricted to use only by other participants who have first used that participant's first contact information to contact that participant and whose contact of that participant has been answered by that participant. The method may further include allowing each participant to retrieve from the network site the contact information that has been provided by other participants. The method may still further include preventing each participant (acting as a contacting participant) from using the second contact information for another participant (acting as a contacted participant) until after the contacting participant has used the contacted participant's first contact information to contact the contacted participant and the contacted participant has answered the contacting participant.

In accordance with certain other possible aspects of the invention, a method of facilitating an event that will have a plurality of participants may include creating a network site for the event, and allowing each participant to post contact information for that participant on the site. Each participant who has thus posted contact information can download from the site (to that participant's network device) the contact information of the other participants. The method may further include displaying on a display of each participant's network device an icon indicative of the presence of downloaded contact information. The method may still further include causing the icon on a participant's display to become less visually prominent if that participant does not use the downloaded contact information within a first time period.

Further features of the invention, its nature and various advantages, will be more apparent from the accompanying drawings and the following detailed description.

### BRIEF DESCRIPTION OF THE DRAWINGS

FIGS. 1a-e are collectively a simplified flow chart of certain possible aspects of an illustrative embodiment of the invention. FIGS. 1a-e may sometimes be referred to collectively as FIG. 1.

FIGS. 2a-d are collectively a simplified flow chart of certain other possible aspects of an illustrative embodiment of the invention. FIGS. 2a-d may sometimes be referred to collectively as FIG. 2.

FIG. 3 is a simplified flow chart of certain still other possible aspects of an illustrative embodiment of the invention.

FIG. 4 is a simplified flow chart of an illustrative embodiment of possible additional method steps in accordance with the invention.

FIG. 5 is a simplified, partial view of an illustrative embodiment of apparatus in use in accordance with the invention.

FIG. 6 is similar to FIG. 5 for another condition of use of the illustrative apparatus in accordance with the invention.

FIG. 7 is again similar to FIGS. 5 and 6 for yet another condition of use of the illustrative apparatus in accordance with the invention.

### DETAILED DESCRIPTION

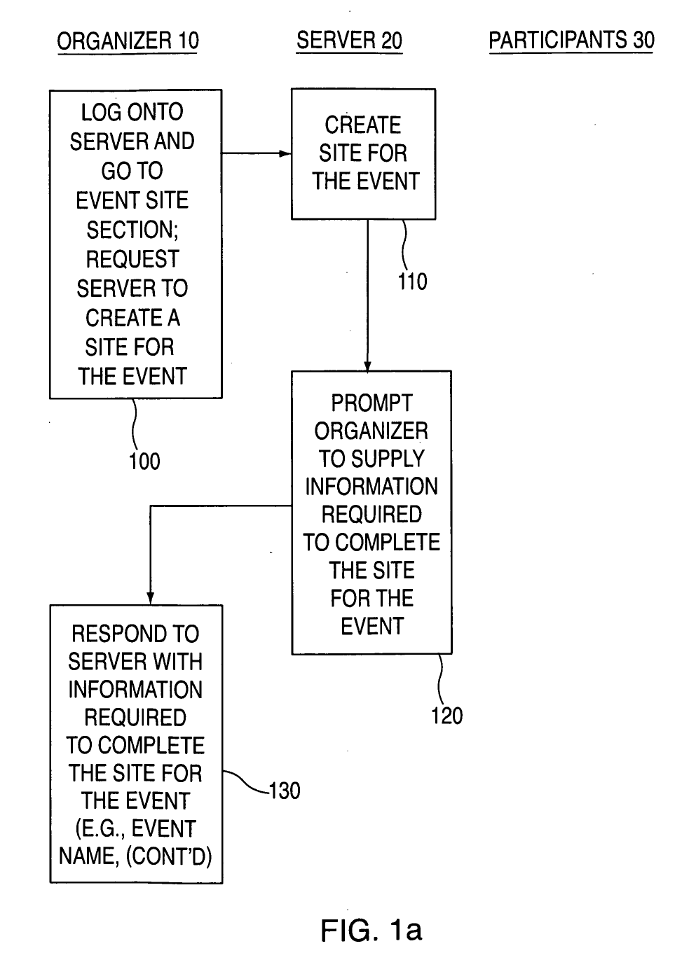

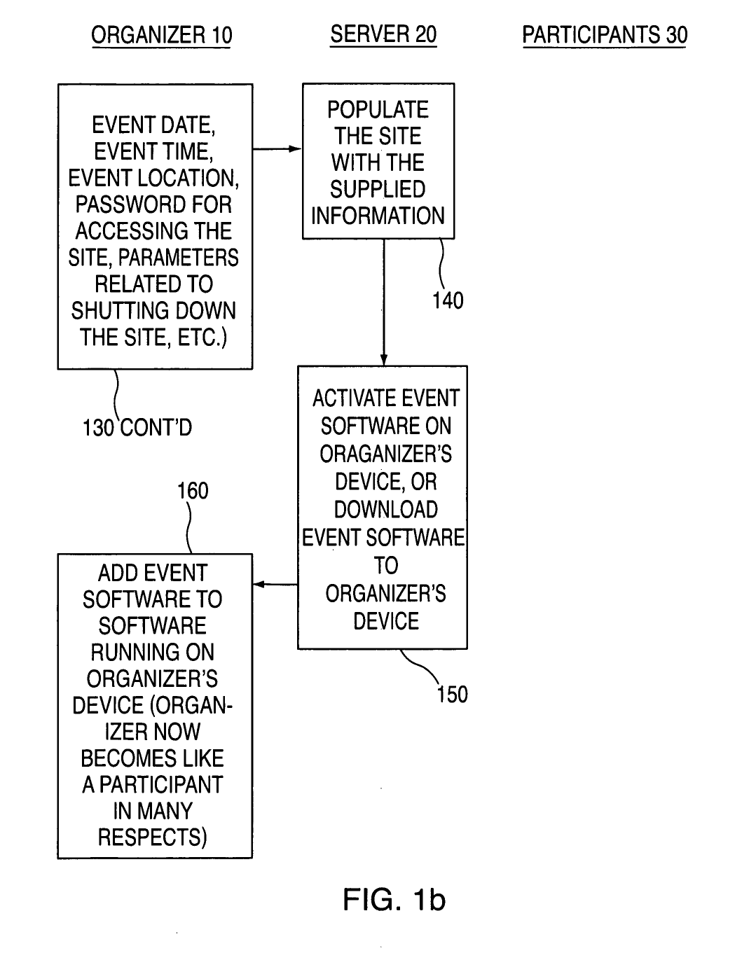

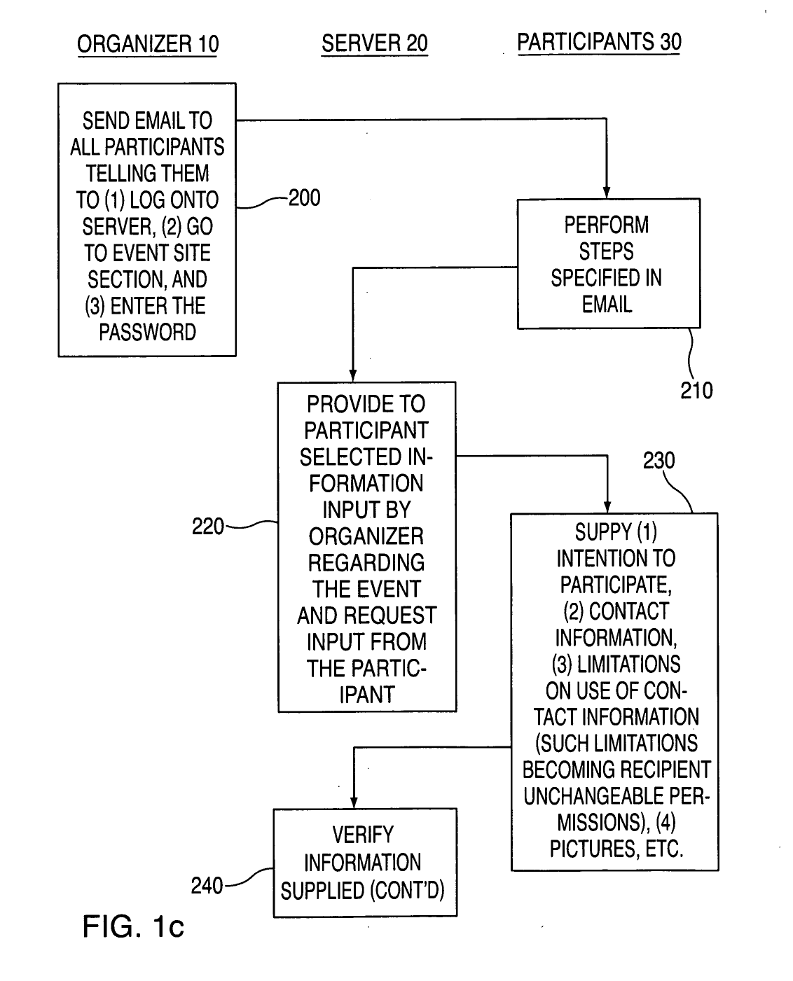

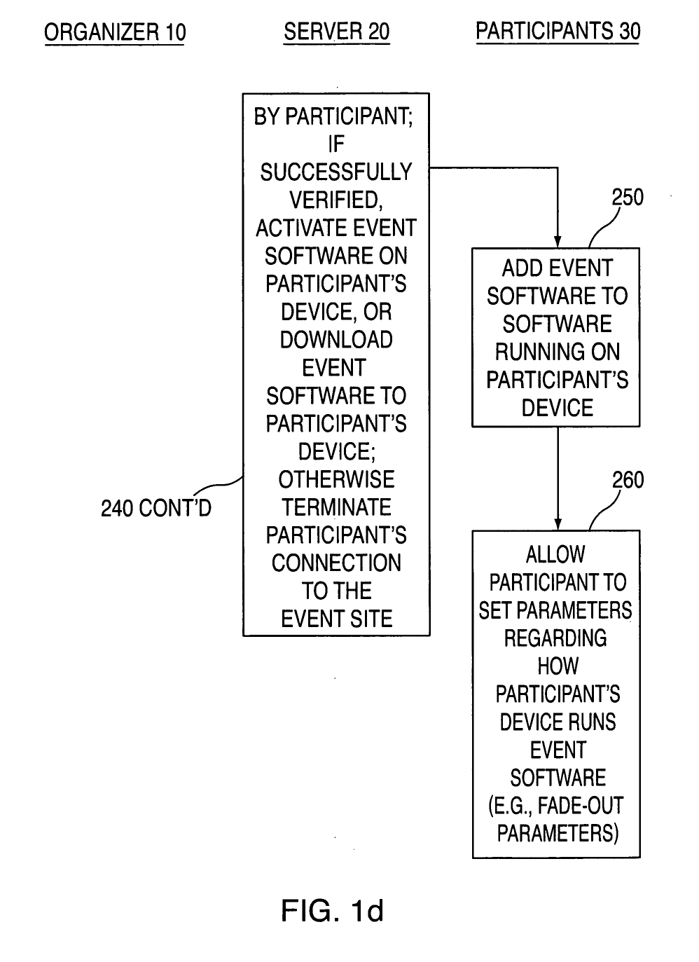

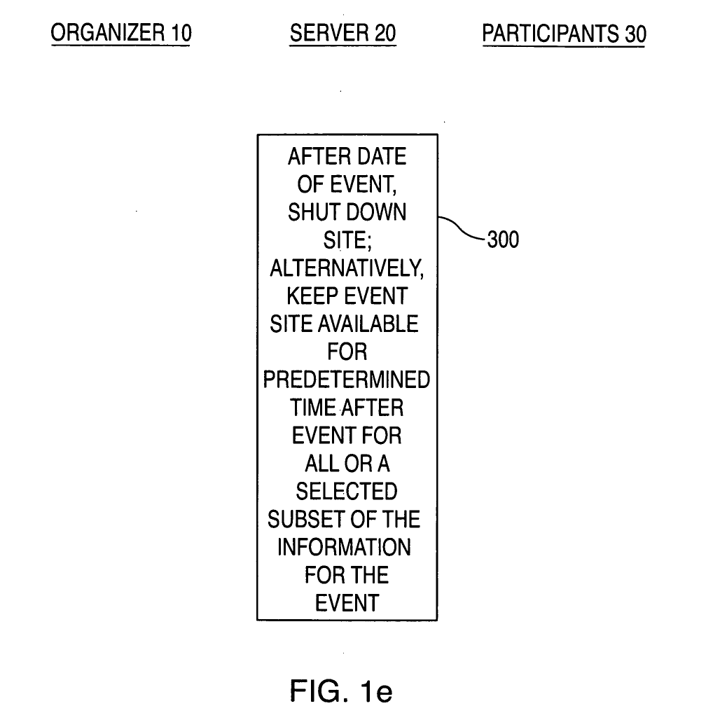

As shown in FIG. 1, the parties to an event are typically an organizer 10, a server 20, and a plurality of participants 30. The term “organizer” typically means, in this context, at least one person who is organizing the event, and one or more network devices used by that person (or other persons helping that person). (For simplicity in the ensuing discussion, it will generally be assumed that only one person is involved as part of what is referred to as organizer 10.) The network devices referred to above may be one or more microcomputers (e.g., Macintosh™ computers or personal computers (PCs)), iPod™ devices, iPhone™ devices, Blackberry devices, or the like). (Macintosh™ computers and iPod™ and iPhone™ devices are available from Apple Inc. of Cupertino, Calif., which owns the trademark rights thereto.)

The term “server” typically means, in this context, a network device (e.g., a minicomputer) that can act as a central point (e.g., via the Internet) for managing the flow of at least some information to, from, and/or between organizer 10 and participants 30.

The term “participant” means, in this context, a person who may participate in (e.g., attend) the event, and one or more network devices used by that person. The network devices referred to in this paragraph may be similar to any of the network devices mentioned in the paragraph before the immediately preceding one.

FIG. 1 shows, inter alia, an illustrative embodiment of how an organizer 10 may use server 20 to create a site for an event that the organizer is organizing, and how possible participants 30 in the event may use that event site to get information about the event, etc. Steps in the left-hand column in FIG. 1 are typically carried out by organizer 10. Steps in the center column in FIG. 1 are typically performed by server 20. Steps in the right-hand column in FIG. 1 are typically performed by each participant 30. Because communication between organizer 10 and server 20, and between participants 30 and server 20 is typically via a network (e.g., via the Internet), the event site on server 20 will sometimes be referred to as a network site.

In step 100 organizer 10 uses his or her network device to (1) log onto server 20 (e.g., via the Internet) and (2) go to an event site section of the server. Also in step 100 the organizer uses his or her network device to request the server to create a site for the event the organizer is organizing.

In step 110 server 20 creates a site for the event, and then in step 120 the server prompts organizer 10 to supply the information required to complete the site for the event.

In step 130 the organizer 10 uses his or her network device to respond to server 20 to supply the information required to complete the site. Examples of such information may include the name of the event, the date of the event, the time of the event, the location of the event, a password to be used (e.g., by participants 30) for accessing the site, parameters relating to shutting down the site after the event, etc. For example, the parameters for shutting down the site may include how long after the event the site is to remain available for continued access by participants. In some cases it may be desired to shut down the site (no further access) immediately after the event. In other cases it may be desired to keep the site available for access for a certain amount of time after the event. In certain cases it may be desired for the shut-down to be phased in over time (e.g., no new information may be entered after a certain time following the event, but information may still be retrieved for a further certain time following the event).

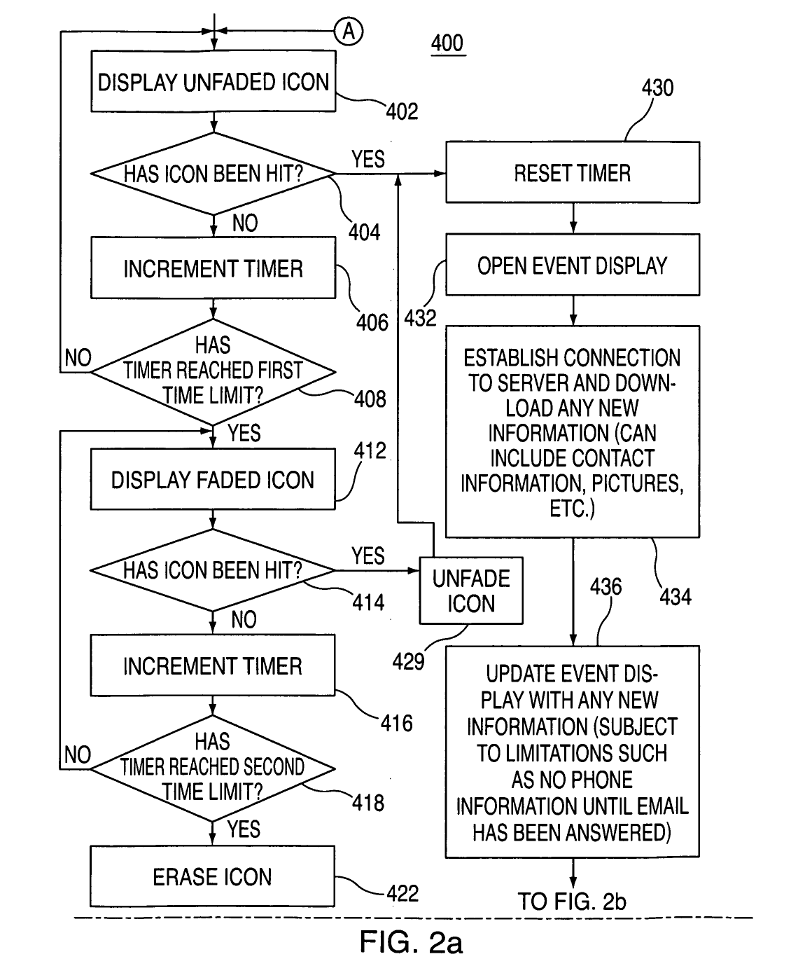

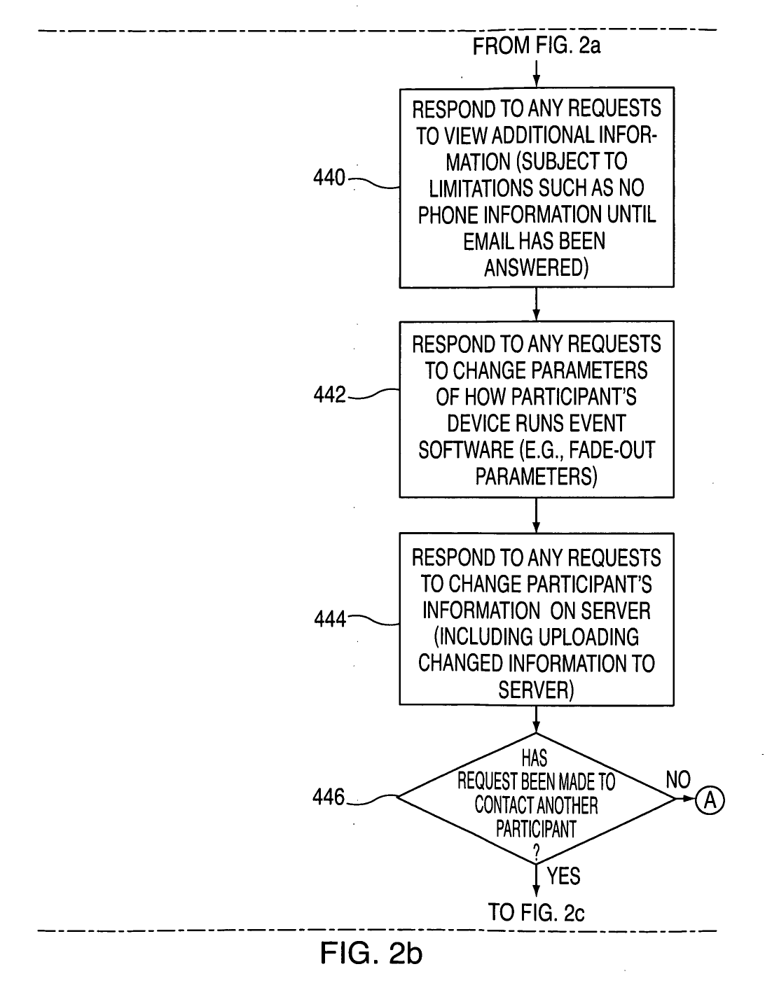

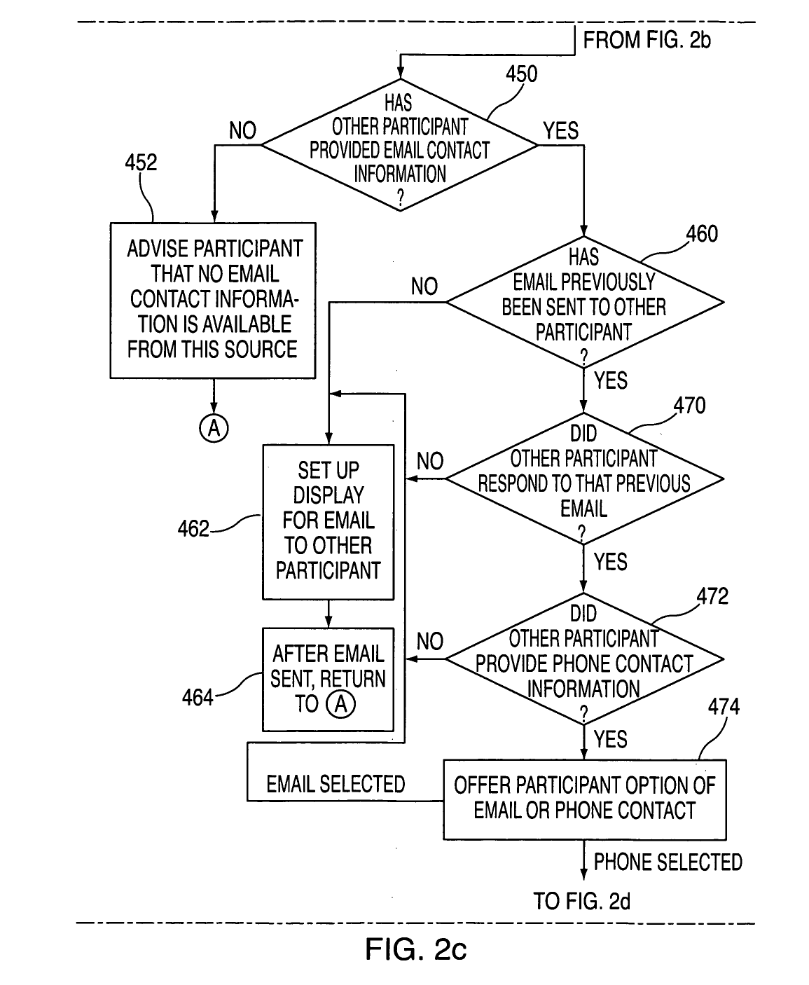

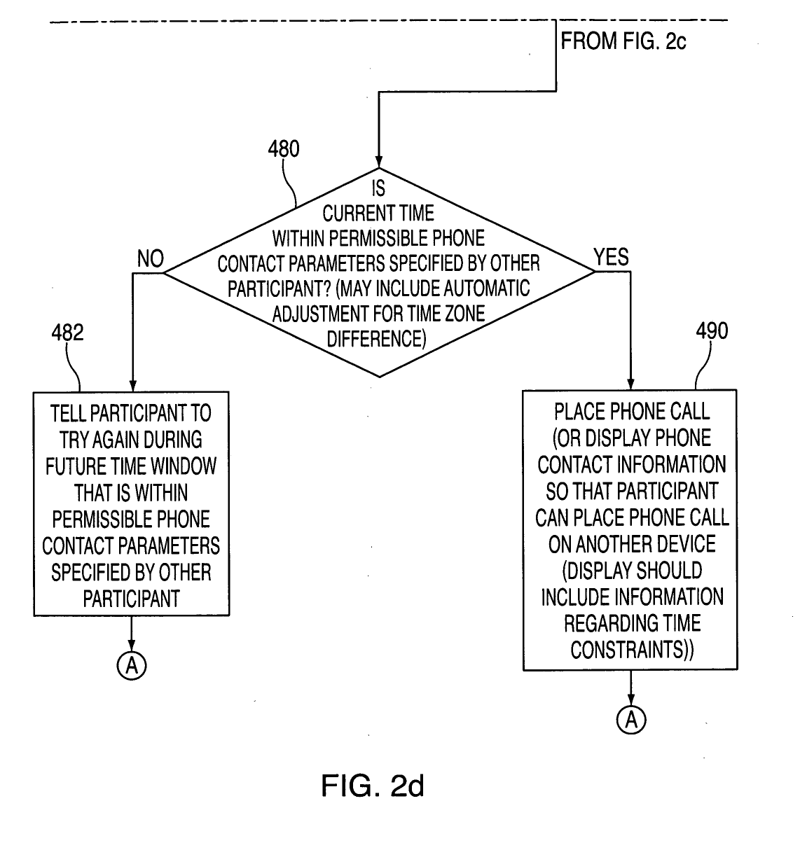

In step 140 server 20 populates the event site with the information organizer 10 has supplied. Then in step 150 the server activates event software on the organizer's device (or downloads that software to the organizer's device). The event software thus referred to may include software as specified by the flow charts shown in FIGS. 2-4, which are described later in this specification.

In step 160 the organizer's device adds the event software (referred to in step 150) to the software running on the organizer's device. The organizer can use this software very much like any participant will later be able to use this software, and in that context organizer 10 becomes like a participant 30 in many respects.

As an alternative to steps 150 and 160, the event software may be built into the organizer's network device and may therefore always be running, at least in the background, on that device. In such a case, steps 150 and 160 may not be necessary and can be omitted. Instead, all that may be required is for performance of any earlier step to include bringing out an event icon in the display of the organizer's device (e.g., as in step 402 in later-described FIG. 2). The organizer will then only need to download the contact information (including “recipient unchangeable” permissions) that other participants subsequently place on the server (e.g., as part of performing step 230, described later in this specification); the download of contact information thus referred to occurring, for example, in later-described step 434).

After the event site has been set up on server 20 as described above, organizer 10 can perform step 200 to send a communication (e.g., an email message) to each possible participant 30 telling each participant to (1) log onto server 20 (e.g., via the Internet), (2) go to the event site section on the server, and (3) enter the password (previously specified by the organizer in step 130).

In step 210 a typical participant 30 takes the actions specified in the organizer's step 200 communication.

In step 220 server 20 provides to the participant from step 210 selected information about the event (e.g., from step 130), and the server requests certain information from the participant.

In step 230 the participant supplies to server 20 such information as (1) whether or not the participant intends to participate in (e.g., attend) the event, (2) the participant's contact information (e.g., email address(es), telephone number(s), etc.), (3) any limitations the participant wants to place on use of any of the contact information, (4) pictures the participant wants to post on the event site, etc. With regard to item (3) above, the participant may not want to receive telephone calls from other participants until after further authorization by the first-mentioned participant. That is an example of a limitation the participant may place on use of his or her contact information. The participant may require the further authorization to be given only to other participants specifically identified by the participant. The participant may specify that such further authorization is automatically granted for any other participant whose email message to this participant is answered by an email from this participant. This type of gradually increasing access to contact information provided to other participants (either generally or specifically) may be referred to as a “fade-in” feature of the invention.

Another example of limitations on use of contact information a participant may specify is days and/or times when the participant does not want to receive telephone calls. Information regarding limitations of this kind may include information about the participant's time zone, so that these limitations can be automatically converted to times in another participant's time zone who may attempt to call the first-mentioned participant. For example, if the first-mentioned participant does not wish to be called between 10 PM and 9 AM, and if the other participant is in a time zone two hours to the east of the first participant, the other participant will be told not to call (or be precluded from calling) between midnight and 11 AM on clocks in the other participant's time zone. A participant can be informed of such time limitations on calling another participant. As another example, a participant's device may mask or otherwise make unreadable or unusable another participant's telephone number(s) during the times when the first-mentioned participant should not call the other participant. As still another example, in a “fully connected” environment, in which telephone calling is tied into other aspects of the system, the system may block any telephone calls from one participant to another at a time when the other participant does not wish to receive calls. For example, this may be done by having the receiver participant's telephone block a call coming in from another participant during call “quiet times” designated by the receiver participant. (The receiver participant's equipment can determine that this is a call from another event participant because the caller's telephone number is in information the receiver participant's equipment has as a result of performance(s) of step 434 (discussed later in this specification) by that equipment.)

The limitations that a participant may place on use of that participant's contact information (as described above in connection with step 230) may sometimes be described as “recipient unchangeable permissions.” This means that these limitations go to any other participant who downloads contact information from server 20 (i.e., the limitations are downloaded as part of download of the associated contact information), but the downloading participant (the “recipient”) cannot change those limitations.

In step 240 server 20 attempts to verify certain of the information participant 30 has supplied in step 230. For example, server 20 may perform Internet searches to verify name, email address, telephone number, and/or other information supplied to the server in step 230. If verification is successful, server 20 may then proceed to activate event software on the participant's device (or to download such software to the participant's device). This part of step 240 can be similar to earlier step 150 (except that it is now applied to a participant 30, rather than to organizer 10). On the other hand, if server 20 cannot verify the information supplied by the participant, server 20 may terminate the participant's connection to the server. (The following discussion assumes that verification was successful.)

In step 250 the participant's device adds the event software to the software running on that device. This step can be similar to earlier step 160 (except that it is now applied to a participant 30, rather than to organizer 10).

As noted in the two preceding paragraphs, certain aspects of steps 240 and 250 are similar to steps 150 and 160. The alternative described above in connection with steps 150 and 160 is therefore again a possible alternative in connection with steps 240 and 250. In particular, as an alternative to parts of steps 240 and 250, the event software may be built into the participant's network device and may therefore always be running (at least in the background) on that device. In such a case, portions of step 240 and 250 may not be necessary and can be omitted. Instead, all that may be required is for performance of an earlier step (e.g., step 210) to include bringing out an event icon on the display of the participant's device (e.g., as in step 402 in later-described FIG. 2). The participant will then only need to download the contact information (including “recipient unchangeable” permissions) that the organizer and other participants have placed on the server (the “download” thus referred to occurring, for example, in later-described step 434; the placing of contact information on the server thus referred to occurring, for example, in steps like 230 and 444).

In step 260 the event software (now running on the participant's device) allows the participant to set certain parameters regarding how that software will operate for that participant. An example of such parameters includes how information (e.g., other participant contact information) the participant received regarding the event may gradually recede into less prominence on the participant's device, and ultimately disappear from availability on that device. Thus the participant may specify what information should recede and/or disappear, on what time schedule and/or usage schedule the information should recede and/or disappear, etc. This may be referred to as a “fade-out” feature of the invention.

Step 300 specifies that after the event, server 20 may shut down the site for that event (e.g., make no more access to that site available). Alternatively, step 300 may keep the site available for a predetermined time after the event. This continued availability may be for all information on the site or for only a predetermined subset of the information on the site. Step 300 may execute shut-down parameter instructions earlier supplied to server 20 as part of step 130.

Although not specifically shown in FIG. 1, the method typically includes giving organizer 10 an opportunity to perform steps like 230 and 260. This is part of what is meant by the reference in step 160 to organizer 10 becoming like a participant 30 in many respects after the event site has been set up. In subsequent references to steps 230 and 260 it will be assumed that those steps have been performed by organizer 10 as well as by participants 30.

FIG. 2 shows an illustrative embodiment of various aspects of event software 400 that can run on the network devices of an organizer 10 or a participant 30. This can be part of the software that is discussed above in relation to steps 150/160 and 240/250 in FIG. 1. The left-hand column of steps in FIG. 2a can relate to a fade-out aspect of the invention. These steps will be described first to provide a concise description of this fade-out feature. Later, the branches away from this series of steps will be described. All of the following discussion of FIGS. 2-4 will assume that software 400 is running on a participant's device and being used by a participant. It will be understood, however, that the user of this software may also be organizer 10 using the organizer's device. Thus, in this discussion, “participant” is generic to organizer 10 and participants 30. A similarly generic term that is sometimes used is “user”.

In a “stand-by” mode, event software 400 may display an “unfaded” icon for the event (or for the event software generally) on a display screen of the participant's device. This is step 402 in FIG. 2a. The term “unfaded” just refers to a full-strength, full-brightness, “foreground,” full-prominence, “solid-line,” or “solid-image” icon of the type that is intended to readily attract the attention (typically among other icons on the display screen) of a user who is looking for it.

Step 404 is performed periodically to determine whether or not the icon of step 402 has been hit (e.g., selected by moving a cursor over the icon and then “clicking” on it using a mouse that is part of the participant's device). If the icon has not been hit, control passes to step 406, in which a timer (e.g., a software timer) is incremented. (The branch to step 430 will be discussed later.)

Following step 406, step 408 is performed to test whether or not the timer has reached a first predetermined time limit. This time limit may be one of the parameters that the participant is allowed to set in above-described step 260 (i.e., it may be one of the fade-out parameters referred to in step 260). If the first time limit has not been reached, control returns to the start of the loop. On the other hand, if step 408 determines that the timer has reached the first time limit with the unfaded icon never having been hit, then control passes from step 408 to step 412, in which the unfaded icon (as in step 402) is converted to a “faded” icon. A “faded” icon is one that (relative to an unfaded icon) is less visibly strong, less visibly bright, less visibly prominent, more apparently in the background, more ghost-like, shaded-over, made up of thinner and/or broken lines, and thus intended to be relatively less attractive to the attention of the user. The faded icon therefore makes the event or event software seem less important to the user. Nevertheless, the icon can still be selected if desired to get into other parts of the event software. Once step 412 has been reached, display of the faded icon is a new stand-by mode of software 400.

After the icon has been faded, step 414 is periodically performed to test whether or not the (faded) icon has been hit. If not, control passes from step 414 to step 416 in which the above-mentioned timer is further incremented. On the other hand, if step 414 finds that the icon has been hit, control passes from step 414 to step 429 (a branch that will be discussed later).

From step 416, control passes to step 418, in which a determination is made as to whether or not the timer has reached a second predetermined time limit. This second time limit may again be a fade-out parameter set by the user (e.g., in above-described step 260). If step 418 determines that the second time limit has not yet been reached, control loops back to step 412 to continue the display of the faded icon. On the other hand, if step 418 determines that the second time limit has been reached, control passes to step 422, in which the icon is erased from the display on the user's device. This may effectively end the user's ability to use software 400. The event software and all associated event information has effectively faded from the user's device.

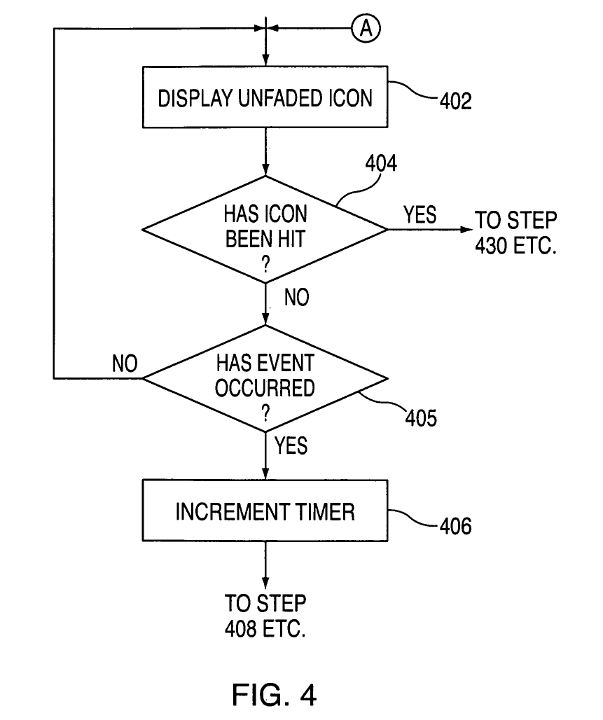

FIG. 4 shows a possible modification of part of what has just been described. If desired, another step 405 can be included between steps 404 and 406. In step 405, software 400 determines whether or not the event has already occurred (e.g., based on a comparison of the date of the event and the current actual date). If the event has not yet occurred, then step 405 prevents control from passing to step 406, and instead forces control back to the start of the loop. This keeps the user's device displaying the unfaded icon (as in step 402). In other words, the scheduled fade-out of the icon, etc., cannot begin until after the event has occurred. The FIG. 4 option may be an option selectable by the user (e.g., as part of the entry of fade-out parametric information in step 260).

We turn now to a discussion of other branches in the software flow shown in FIG. 2a.

If the event icon is hit in step 404, control passes from that step to step 430, in which the fade-out timer (referred to in steps like 406) is reset. Similarly, if in step 414 the faded icon is found to have been hit, control passes from that step to step 429, in which the icon is unfaded (i.e., restored to the step 402 condition), and following which control passes to step 430.

From step 430, control passes to step 432, in which an event display is opened on the display screen of the user's device. The event display referred to in step 432 may in fact be more than one screenful of information, and the user may be able to navigate back and forth among several such screens of information.

After step 432, control passes to step 434, in which the user's device establishes a connection (e.g., via the Internet) to server 20. This connection is then used to download any new information about other participants that is available on the event site on the server. This information can include contact information, pictures, etc. that the other participants have placed in the event site.

In step 436 the event display on the user's device (from step 432) may be updated with new information from the download in step 436. Not all of the downloaded information may be actually displayed and therefore made available to the user at this time. For example, some of this information may come with limitations on use. Unless and until those limitations have been satisfied by a particular user, that user's device may be prevented from displaying information subject to such unsatisfied limitations. For example, a participant may have provided (e.g., in the step 230) a telephone number that the participant has specified should not be usable by any other participant until after the other participant has sent an email to the first-mentioned participant and the first-mentioned participant has responded (e.g., by email) to the other participant. Then if the other participant is the user in this discussion of step 436, that user's device will not display (or otherwise make usable) the first-mentioned participant's restricted telephone number until after this user has emailed the first-mentioned participant and received a reply from the first-mentioned participant. This is an example of how each participant can control which other participants can use the first-mentioned participant's restricted contact information. Such restricted contact information thus “fades in” for each participant who is able to satisfy the limitations on availability and use of another participant's restricted information.

Step 440 is somewhat similar to step 436 for any information that is not immediately displayed in the “foreground” display referred to in step 436. In other words, if in addition to the step 436 foreground display, the user can request additional “background” displays or screens, step 440 responds to such user requests for background displays, but does so subject to the same possible limitations that are referred to in step 436 and described above.

From step 440, control passes to step 442, in which the software responds to any requests by the user to change the parameters relating to how the user's device runs the event software. This is similar to step 260, but it gives the user an opportunity to change parameters initially set in step 260 if the user wants to make any such changes.

From step 442, control passes to step 444, in which the software responds to any requests by the user to change (or add to or delete from) the user's information on the event site on server 20. Step 444 includes uploading the changed information to server 20. Step 444 is similar to step 230, but it gives the user an opportunity to change (including adding to and/or deleting) any of the information initially provided in step 230.

From step 444, control passes to step 446, in which the user is given an opportunity to make a request to contact another participant. If the user has not made such a request, control loops back to the start of the FIG. 2 software (i.e., step 402). On the hand, if the user has made a request to contact another participant, control passes from step 446 to step 450.

In step 450 a determination is made as to whether or not the participant the user wants to contact (per step 446) has provided email contact information. If not, control passes to step 452, in which the user is advised that no email contact information has been provided by the other participant, and control then loops back to the start of the FIG. 2 software. On the other hand, if the other participant has provided email contact information, the control passes from step 450 to step 460.

In step 460 a determination is made as to whether or not this user previously sent an email to this other participant. If not, control passes from step 460 to step 462. (The other branch from step 460 will be considered later.)

In step 462 the display of the user's device is set up to allow the user to send an email to the other participant. The user can then enter the message to be sent, and send the email. After the email has been sent (step 464), control loops back to the start of the FIG. 2 software.

Returning now to the other branch from step 460, if an email has already been sent to the other participant, control passes from step 460 to step 470. In step 470 a determination is made as to whether or not the other participant responded to that other email. If not, the other participant has not acted in a way that allows this user to move to a more personal level of communication with this other participant. Accordingly, only email remains an option for this user to contact this other participant. Control therefore passes from step 470 back to previously described step 462, where the user is helped to send another email to the other participant. On the other hand, if step 470 finds that the other participant did answer this user's previous email, then control passes from step 470 to step 472.

In step 472 a determination is made as to whether or not the other participant provided telephone contact information (e.g., as part of step 230). If not, control passes from step 472 back to previously described step 462, where the user is helped to send another email to the other participant. On the other hand, if step 472 finds that the other participant did provide telephone contact information, control passes from step 472 to step 474. Step 472, especially the “yes” branch from step 472, is a manifestation of a “fade-in” feature of this invention. In accordance with this aspect of the fade-in feature, a user of the system cannot use the system to make a more personal level of contact with another participant (e.g., telephone contact) until after that other participant has signaled willingness to permit such more personal contact by responding on a less personal contact level (e.g., by email).

In step 474, the user is offered the option of contacting the other participant by email or telephone. If email is selected, control passes from step 474 back to previously described step 462. On the other hand, if telephone contact is selected, control passes from step 474 to step 480.

In step 480 a determination is made as to whether the current time (including the current day and/or date) is within permissible telephone contact parameters specified by the other participant (e.g., in step 230). As noted in step 480, this determination may include automatic compensation for any difference in time zone between the user and the other participant. If the other participant's telephone contact limitations or constraints are not currently satisfied, control passes from step 480 to step 482, in which the user is advised to try again to make telephone contact with the other participant at a time that is within telephone contact constraints of the other participant. Control then loops back to the start of the FIG. 2 software. On the other hand, if step 480 determines that the current time is acceptable for a telephone call to the other participant, control passes from step 480 to step 490.

In step 490 the user's device places a phone call to the other participant (assuming that the user's device has the ability to make telephone calls). Otherwise, the user's device displays telephone contact information for the other participant so that the user can call the other participant on another device. If the other participant's telephone contact information is displayed, the display should also include information about the other participant's time constraints regarding telephone calls. After step 490 has been performed, control loops back to the start of the FIG. 2 software.

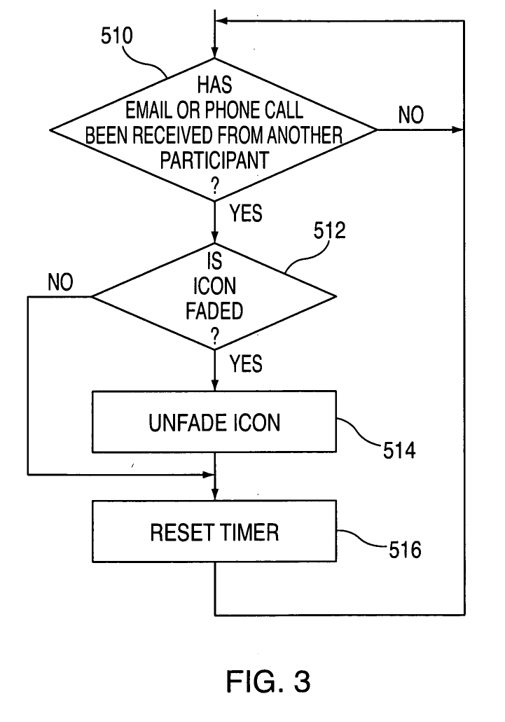

FIG. 3 shows an alternative or additional way that an icon for the event may move from the faded condition (e.g., as a step 412) back to being an unfaded icon (e.g., as in step 402). For example, the steps shown in FIG. 3 can run in parallel with (or as a periodic interrupt to) the steps shown in the left-hand side in FIG. 2a.

In step 510 a determination is made as to whether or not a user has received an email or a telephone call from another participant. If not, nothing is changed. On the other hand, if the user has received an email or a telephone call from another participant, control passes from step 510 to step 512.

In step 512 a determination is made as to whether or not the icon for the event is faded (e.g., as in step 412). If not, control passes from step 512 to step 516. On the other hand, if the icon is faded, then control passes from step 512 to step 514, in which the icon is unfaded. After step 514, control passes to step 516.

In step 516 the timer (also referred to in step 430 and elsewhere in FIG. 2) is reset. Step 516 is therefore another step like step 430. After step 516, control loops back to the start of the FIG. 3 software.

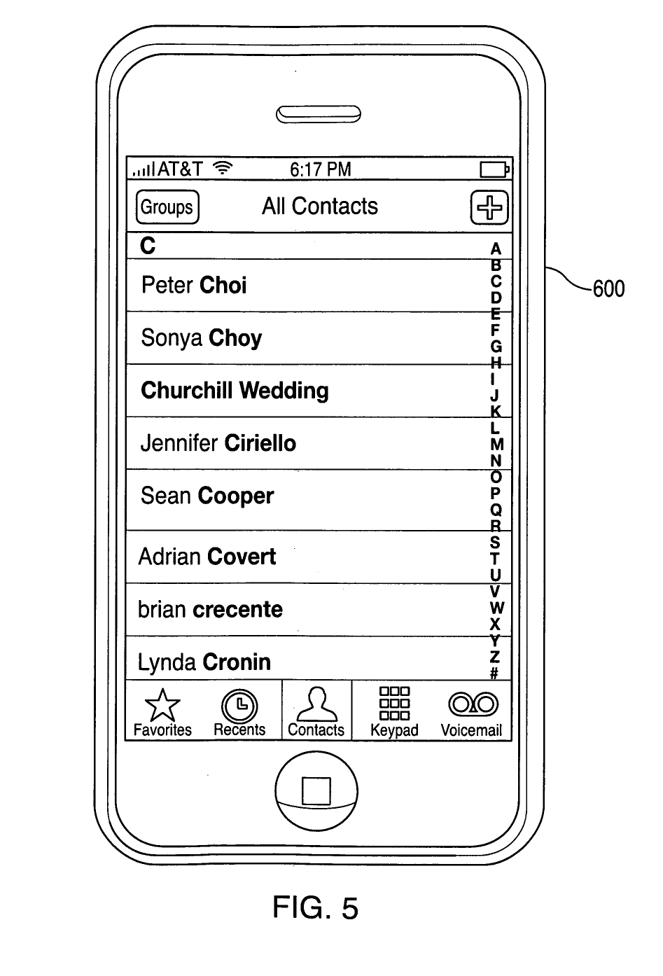

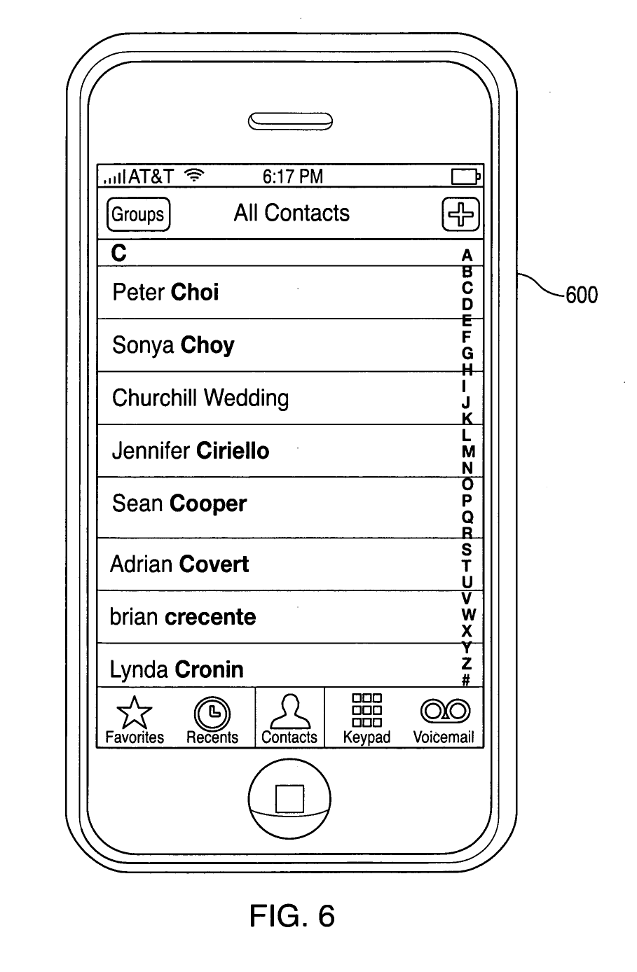

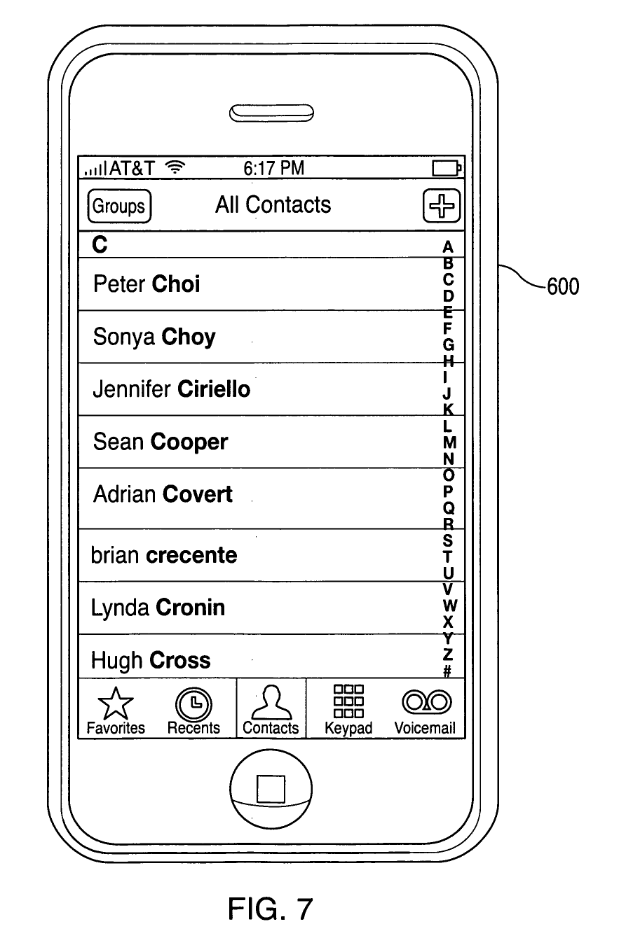

FIGS. 5-7 show an example of how an icon for an event may first appear in full strength (FIG. 5) on the display of a user's network device 600 (in this example an iPhone™ device). In this example the icon (which can be like the icon mentioned in earlier-described step 402) is “Churchill Wedding.” As described elsewhere in this specification, if the icon is not selected by the user for a certain amount of time, then the method of the invention causes the icon to fade to a fainter, less bold icon as shown in FIG. 6. This can be like the faded icon referred to in earlier-described step 412. If, after a still further amount of time, the icon is still not selected by the user, then the method of the invention causes the icon to disappear completely as shown in FIG. 7. This can be like the action taken in earlier-described step 422.

It will be understood that the foregoing is only illustrative of the principles of the invention, and that various modifications can be made by those skilled in the art without departing from the scope and spirit of the invention. For example, various parameters (e.g., the above-mentioned first and second time limits in steps 408 and 418) may be either predetermined by the system or selectable by users of the system.

What is claimed is:

1. A method of facilitating an event that will have a plurality of participants comprising:
allowing each participant to post on a network site for the event first and second contact information for that participant, the second contact information being restricted to use only by other participants who have first used the first information to contact that participant and whose contact of that participant has been answered by that participant;
allowing each participant to retrieve from the site the contact information for other participants; and
preventing each participant (acting as a contacting participant) from using the second contact information for another participant (acting as a contacted participant) until after the contacting participant has used the contacted participant's first contact information to contact the contacted participant and the contacted participant has answered the contacting participant.

2. The method defined in claim 1 wherein the first contact information is email contact information.

3. The method defined in claim 1 wherein the second contact information is telephone contact information.

4. The method defined in claim 3 wherein the second information includes a limitation as to when during a day that it may be used.

5. The method defined in claim 4 wherein the preventing includes:
further preventing the contacting participant from using the second contact information of the contacted participant at a time of day that is inconsistent with the limitation as to time of day included in the contacted participant's second contact information.

6. The method defined in claim 5 wherein the further preventing automatically compensates for any time zone difference between the contacting participant and the contacted participant.

7. The method defined in claim 1 further comprising:
allowing each participant to post a picture on the site; and
allowing each participant to retrieve from the site pictures posted on the site by other participants.

8. The method defined in claim 1 further comprising:
preventing a participant who has not posted contact information on the site from retrieving contact information for other participants from the site.

9. The method defined in claim 1 further comprising:
verifying the contact information posted on the site by a participant before allowing that participant to retrieve contact information for other participants from the site.

10. A method of facilitating an event that will have a plurality of participants comprising:
creating a network site for the event;
allowing each participant to post contact information for that participant on the site;
allowing each participant who has posted contact information to download from the site to that participant's network device the contact information of the other participants;
displaying on a display of each participant's network device an icon indicative of the presence of downloaded contact information; and
causing the icon on a participant's display to become less visually prominent if that participant does not use the downloaded contact information within a first time period.

11. The method defined in claim 10 wherein the first time period cannot start until after the event has taken place.

12. The method defined in claim 10 further comprising:
causing the icon to disappear from a participant's display if that participant does not use the downloaded contact information within a second time period, which is greater than the first time period.

13. The method defined in claim 10 further comprising:
restarting the first time period for a participant in response to that participant's receipt of a communication from another participant.

14. The method defined in claim 10 further comprising:
restoring to greater visual prominence the icon of a participant that has become less visually prominent when that participant uses the downloaded contact information.
